(19) United States
(12) Patent Application Publication
(10) Pub. No.: US 2016/0049773 A1
(43) Pub. Date: Feb. 18, 2016

(54) CORONA IGNITION DEVICE

(71) Applicant: BorgWarner Ludwigsburg GmbH, Ludwigsburg (DE)

(72) Inventors: Timo Stifel, Stuttgart (DE); Markus Müller, Tamm (DE)

(21) Appl. No.: 14/820,079

(22) Filed: Aug. 6, 2015

(30) Foreign Application Priority Data
Aug. 15, 2014 (DE) 10 2014 111 684.4

(51) Int. Cl. H01T 19/00; F02P 23/04

(52) U.S. Cl. CPC H01T 19/00; F02P 23/04

(57) ABSTRACT

A corona ignition device comprising a center electrode that leads to at least one ignition tip, an insulator in which the center electrode is located, a metal housing that holds the insulator, wherein the insulator has an electrically conductive coating extending on the outside of the insulator over a portion of the length thereof. According to this disclosure an end section of the coating that faces away from the ignition tip is covered by a dielectric coat.

### RELATED APPLICATIONS

This application claims priority to DE 10 2014 111 684.4, filed Aug. 15, 2014, the entire disclosure of which is hereby incorporated herein by reference in its entirety.

### BACKGROUND

The invention relates to a corona ignition device comprising a center electrode that leads to at least one ignition tip, an insulator, in which the center electrode is located, and a metal housing that holds the insulator. A corona ignition device having the features specified in the preamble of the claim 1 is known from DE 10 2009 059 649 A1.

Corona ignition devices effect an ignition in internal combustion engines by means of a corona discharge and therefore are an alternative to conventional spark plugs which effect an ignition by means of an arc discharge.

A common reason for premature failure of corona ignition devices is partial discharges and flashovers inside the corona ignition device. An electrically conductive coating on the insulator body can improve the dielectric strength of the insulator and therefore can reduce the occurence of partial discharges and flashovers.

### SUMMARY

This disclosure shows how partial discharges and flashovers in the interior of a corona ignition device can be avoided in an even better manner.

In the case of a corona ignition device according to this disclosure, an end section of the electrically conductive coating is covered by a dielectric coat. The risk of internal partial discharges and flashovers can be further reduced in this manner. This risk is due to the fact that local field enhancements might form at the end of the electrically conductive coating which, under unfavorable conditions, can result in flashovers and partial discharges. By covering the end of the coating with a dielectric coat, the dielectric strength can be increased at this particularly susceptible area and the occurrence of partial discharges and flashovers can be counteracted.

The electrically conductive coating has an end at the combustion chamber side, i.e., an end facing towards the at least one ignition tip, and an end distant from the combustion chamber, i.e., an end facing away from the at least one ignition tip. The dielectric coat covers the end section of the electrically conductive coating that is distant from the combustion chamber.

The dielectric coat can be deposited from the gas phase, for example by chemical vapor deposition. Another possibility is to apply the dielectric coat in the form of an ink, a lacquer or paste, which can be fired or sintered after its application. In principle, any insulators are suitable as material for the dielectric coat, in particular polymers such as parylene, as well as ceramics.

An advantageous refinement of this disclosure provides that the dielectric coat has a greater thickness than the electrically conductive coating. In this manner, a particularly high dielectric strength and therefore a particularly effective protection against partial discharges and internal flashovers can be achieved.

Another advantageous refinement of this disclosure provides that the insulator has a first insulator section against which the housing rests, and a second insulator section that adjoins the first insulator section and which is surrounded at a distance by the housing, wherein the electrically conductive coating covers the first insulator section and a portion of the second insulator section, and wherein the coat is arranged only on the second insulator section.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a schematic sectional view of an illustrative embodiment of a corona ignition device;

FIG. 2 shows a schematic detailed view of the end of a corona ignition device at the side of the combustion chamber; and

FIG. 3 shows a schematic detailed view of FIG. 2.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

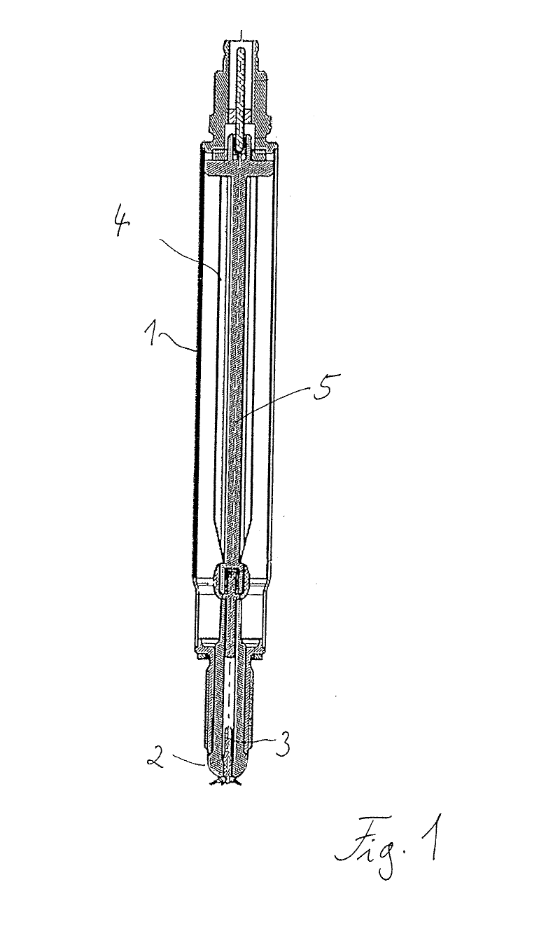

The corona ignition device schematically illustrated in FIG. 1 in a longitudinal section generates a corona ignition for igniting fuel in a combustion chamber of an engine. The corona ignition device has an insulator 2 that is held by a metal housing 1. A center electrode 3 having one or more ignition tips protrudes out of the insulator's 2 front end at the combustion chamber. A section of the center electrode 3 can be formed from electrically conductive glass that seals the channel through which the insulator 2 runs.

The center electrode 3 together with insulator 2 and the housing 1 form a capacitance that is connected in series with a coil 4 connected to the center electrode 3. The coil 4 is composed of a wire that is wound onto a coil body 5. This capacitance and the coil 4 are part of an electrical resonant circuit, by the excitation of which corona discharges can be generated at the ignition tips or the ignition tip of the center electrode 3.

In the embodiment shown, the coil 4 is arranged in the metal housing 1 in which the insulator 2 is located. The coil 4 can also be arranged outside of the housing 1 and can be connected to the center electrode 3 via a cable, for example.

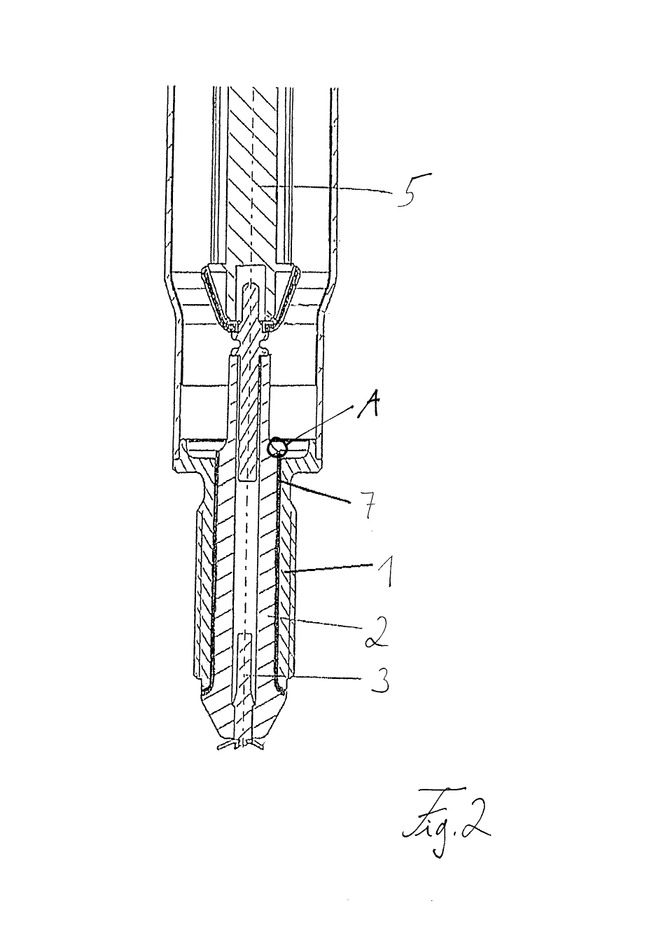

FIG. 2 shows as an enlargement the front section of such a corona ignition device. The front section is located on the combustion chamber side. It can be seen that the insulator 2 is provided with an electrically conductive coating 7 extending over a portion of its length. The coating 7 can be made, for example, from metal or an electrically conductive ceramic. An end section of the insulator protruding out of the metal housing 1 can be free from the electrically conductive coating 7.

In the embodiment shown, a rear end section of the insulator 2 distant from the combustion chamber is free from the electrically conductive coating 7. Thus, the insulator 2 extends farther towards the housing's 1 end distant from the combustion chamber than the electrically conductive coating 7.

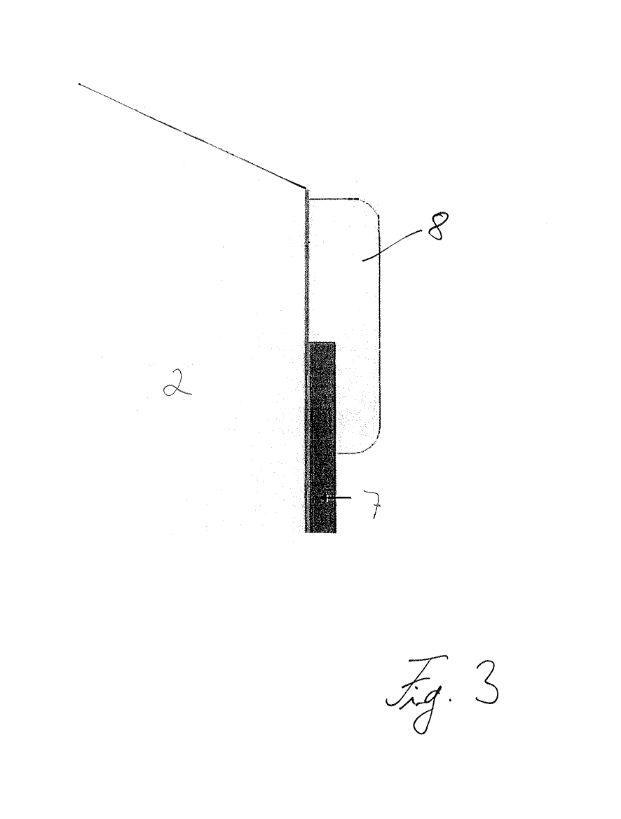

FIG. 3 schematically shows an enlarged view of the image detail A of FIG. 2. FIG. 3 also shows an enlarged view of the insulator 2 including the rear end section of the electrically conductive coating 7, namely the end section distant from the combustion chamber, thus the end section of the electrically conductive coating 7 of the insulator 2 that faces away from the ignition tip or the ignition tips. The end section of the coating 7 distant from the combustion chamber is covered by a dielectric coat 8. The dielectric coat 8 can also cover, in addition to the end section of the electrically conductive coating 7 facing away from the ignition tip, a section of the insulator 2 adjoining this end section of the electrically conductive coating 7. The dielectric coat 8 can be a polymer or a ceramic, for example. The dielectric coat 8 prevents that a partial discharge forms at the end of the electrically conductive coating 7 or that a flashover occurs, and thus increases the service life of the corona ignition device.

The dielectric coat 8 can be thicker than the electrically conductive coating 7, as is illustrated in FIG. 3. The dielectric coat may have a thickness of 5 μm or more. The thickness of the dielectric coat 8 can be selected to be as great as desired. However, increasing the thickness beyond 0.1 mm normally has no substantial advantages.

As FIG. 2 shows, the metal housing 1 has a section that rests against the electrically conductive coating 7. A second section having a larger inner diameter than the first section adjoins this first section of the metal housing 1. The dielectric coat 8 is arranged completely within the second section of the metal housing 1. The metal housing 1 surrounds the dielectric coat 8 at a distance. An annular chamber between the insulator 2 and the second section of the metal housing 1 can be filled with an insulating gas, for example with sulfur hexafluoride or nitrogen. The insulating gas is preferably under pressure, for example 5 bar or higher, so as to achieve a dielectric strength as high as possible.

Thus, the insulator 2 has a first insulator section which the housing 1 touches, and a second insulator section which adjoins the first insulator section and which is surrounded at a distance by the housing 1. The electrically conductive coating 7 is arranged on the first insulator section and a portion of the second insulator section. The dielectric coat 8 is arranged only on the second insulator section. In the embodiment shown, the metal housing 1 thus surrounds the dielectric coat 8 everywhere at a distance.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A corona ignition device, comprising:
a center electrode that leads to at least one ignition tip;
an insulator in which the center electrode is located;
a metal housing that holds the insulator; and
an electrically conductive coating on the outside of the insulator, the electrically conductive coating extending over a portion of the length of the insulator;
wherein an end section of the electrically conductive coating is covered by a dielectric coat, said end section facing away from the ignition tip.

2. The corona ignition device according to claim 1, wherein the dielectric coat also covers, in addition to the end section of the electrically conductive coating, a section of the insulator adjoining the end section of the electrically conductive coating.

3. The corona ignition device according to claim 1, wherein the dielectric coat is thicker than the electrically conductive coating.

4. The corona ignition device according to claim 1, wherein the dielectric coat is a polymer.

5. The corona ignition device according to claim 1, wherein the metal housing has a section that touches the electrically conductive coating.

6. The corona ignition device according to claim 5, wherein the metal housing has a second section that adjoins the section touching the electrically conductive coating, the second section having a larger inner diameter than the section touching the electrically conductive coating, the dielectric coat being arranged completely within the second section.

7. The corona ignition device according to claim 1, wherein the metal housing surrounds the dielectric coat at a distance.

8. The corona ignition device according to claim 1, wherein the insulator has a first insulator section touching metal housing and a second insulator section adjoining the first insulator section and surrounded by the metal housing at a distance, wherein the electrically conductive coating covers the first insulator section and a portion of the second insulator section, and wherein the dielectric coat is arranged only on the second insulator section.

9. The corona ignition device according to claim 1, wherein the dielectric coat is applied by vapor deposition.

10. The corona ignition device according to claim 1, wherein the dielectric coat is applied as a paste.
